(19) United States
(12) Patent Application Publication
(10) Pub. No.: US 2024/0085584 A1
(43) Pub. Date: Mar. 14, 2024

(54) System and Method for Combined Streaming Potential and Controlled-Source Electromagnetic Modeling

(71) Applicant: ESG Solutions Group Inc., Tomball, TX (US)

(72) Inventors: Trevor Keith Charles Pugh, Tomball, TX (US); Jeffrey Chen, Richmond, CA (US)

(21) Appl. No.: 18/464,176

(22) Filed: Sep. 8, 2023

Related U.S. Application Data
(60) Provisional application No. 63/374,930, filed on Sep. 8, 2022.

(51) Int. Cl. G01V 3/12

(52) U.S. Cl. CPC G01V 3/12

(57) ABSTRACT

Techniques for improved modeling of subsurface formations are disclosed that employ a combination of streaming potential and controlled source electromagnetic techniques to gain an improved understanding of subsurface conditions.

### CROSS-REFERENCE TO RELATED APPLICATION

This Patent application claims priority to U.S. Provisional Patent Application No. 1283-0046PUS U.S. 63/374,930 filed on Sep. 8, 2022., entitled “System and Method for Combined Streaming Potential and Controlled-Source Electromagnetic Modeling.” The disclosure of the prior application is considered part of and is incorporated by reference into this Patent Application.

### TECHNICAL FIELD

The present invention relates to the field of geophysics, and in particular to techniques for improved modeling of subsurface formations.

### BACKGROUND ART

The Streaming Potential (SP) technique is a passive geophysical tool that measures naturally occurring electric fields or voltages created by fluid flow through geologic formations. Widely recognized applications of SP techniques range from monitoring dam leakage, estimating hydraulic conductivity in hydrogeology, monitoring volcano and geothermal activities, and well logging in the oil and gas industry. One of the advantages of the SP technique lies in the ease of data acquisition, without an actively man-made exciting source.

According to the electrokinetic theory, two causing sources can generate an SP signal: fluid flow rate and pressure change with time. In the energy industry, for example, during hydraulic fracturing, the borehole pressure changes in a quite low-frequency regime, close to direct current (DC). This is consistent with the general understanding that the mechanism for SP is related to the ion's relative movement due to the Zeta potentials in the double-layer region separating two material phases, for example, between solid and liquid.

On the contrary, the Controlled-Source Electromagnetics (CSEM) method is a popular active source technique that injects different current waveforms into ground or wire loops and then measures the total electric and/or magnetic fields arising from the interactions between the source and the subsurface formations. This means both the signal strength and the frequency content can be controllable, depending upon the depth of the targets of interest and the background formation.

### SUMMARY OF INVENTION

In a first aspect, a method for monitoring carbon capture, utilization, and storage (CCUS) comprises positioning a controlled source electromagnetic (CSEM) transmitter on a surface of the earth relative to a CCUS borehole casing; positioning a plurality of CSEM receivers relative to the CCUS borehole casing, synchronized with the CSEM transmitter; transmitting signals from the CSEM transmitter into a subsurface formation about the CCUS borehole casing; receiving by the plurality of CSEM receivers a secondary electromagnetic (EM) field corresponding to the signals transmitted from the CSEM transmitter coupled with a streaming potential at a location where fluid is being injected into the subsurface formation; measuring the secondary EM field; and calculating a pressure field by performing an inversion on an objective function based on the secondary EM field and a forward modeling function transforming a pressure or gradient of the pressure field to the secondary EM field.

In a second aspect, a method of imaging saturation or permeability of a formation comprises positioning a controlled source electromagnetic (CSEM) transmitter on a surface of the earth relative to a borehole; positioning a plurality of CSEM receivers relative to the borehole, synchronized with the CSEM transmitter; transmitting signals from the CSEM transmitter into a subsurface formation about the borehole; receiving by the plurality of CSEM receivers a secondary electromagnetic (EM) field corresponding to the signals transmitted from the CSEM transmitter coupled with a streaming potential at a location where fluid is being injected into the subsurface formation; measuring the secondary EM field; and calculating a saturation or permeability of the formation by performing an inversion on an objective function based on the secondary EM field and a function transforming saturation or permeability into the secondary EM field.

In a third aspect, a method of determining an injection or flowback rate into or from a subsurface formation comprises positioning a controlled source electromagnetic (CSEM) transmitter on a surface of the earth relative to a borehole; positioning a plurality of CSEM receivers relative to the borehole, synchronized with the CSEM transmitter; transmitting signals from the CSEM transmitter into a subsurface formation about the borehole; receiving by the plurality of CSEM receivers a secondary electromagnetic (EM) field corresponding to the signals transmitted from the CSEM transmitter coupled with a streaming potential at a location where fluid is being injected into the subsurface formation; measuring the secondary EM field; and performing a reservoir simulation based on the injection or flowback rate by performing an inversion on an objective function based on the secondary EM field and a function transforming a pressure or gradient of a pressure field to the secondary EM field.

In a fourth aspect, a method of calculating electrical and magnetic fields in a subsurface formation comprises positioning a controlled source electromagnetic (CSEM) transmitter on a surface of the earth relative to a borehole; positioning a plurality of CSEM receivers relative to the borehole, synchronized with the CSEM transmitter; transmitting signals from the CSEM transmitter into a subsurface formation about the borehole; receiving by the plurality of CSEM receivers a secondary electromagnetic (EM) field corresponding to the signals transmitted from the CSEM transmitter coupled with a streaming potential at a location where fluid is being injected into the subsurface formation; measuring the secondary EM field; and calculating a streaming potential current from a cross-coupling coefficient between a fluid and electric flow and a pressure field; calculating electrical and magnetic fields based on an exciting current and a streaming potential current.

### BRIEF DESCRIPTION OF DRAWINGS

The accompanying drawings, which are incorporated in and constitute a part of this specification, illustrate an implementation of apparatus and methods consistent with the present invention and, together with the detailed description, serve to explain advantages and principles consistent with the invention. In the drawings,

FIG. 1 is a pair of graphs illustrating an example frequency spectral analysis compared with an example borehole pressure data.

FIG. 2 is a pair of graphs illustrating a CSEM project.

FIG. 3 is a pair of graphs from a fracking operation further illustrating the relationship between pressure, injected fluid, proppant, and the scattered field CSEM response.

FIG. 4 is a graph illustrating the results of a non-linear regression performed for all the data in the CSEM scattered field response from the data of FIG. 3.

### DESCRIPTION OF EMBODIMENTS

In the following description, for purposes of explanation, numerous specific details are set forth in order to provide a thorough understanding of the invention. It will be apparent, however, to one skilled in the art that the invention may be practiced without these specific details. In other instances, structure and devices are shown in block diagram form in order to avoid obscuring the invention. References to numbers without subscripts are understood to reference all instances of subscripts corresponding to the referenced number. Moreover, the language used in this disclosure has been principally selected for readability and instructional purposes, and may not have been selected to delineate or circumscribe the inventive subject matter, resort to the claims being necessary to determine such inventive subject matter. Reference in the specification to “one embodiment” or to “an embodiment” means that a particular feature, structure, or characteristic described in connection with the embodiments is included in at least one embodiment of the invention, and multiple references to “one embodiment” or “an embodiment” should not be understood as necessarily all referring to the same embodiment.

Although some of the following description is written in terms that relate to software or firmware, embodiments can implement the features and functionality described herein in software, firmware, or hardware as desired, including any combination of software, firmware, and hardware. References to daemons, drivers, engines, modules, or routines should not be considered as suggesting a limitation of the embodiment to any type of implementation. The actual specialized control hardware or software code used to implement these systems or methods is not limiting of the implementations. Thus, the operation and behavior of the systems and methods are described herein without reference to specific software code with the understanding that software and hardware can be used to implement the systems and methods based on the description herein

As used herein, satisfying a threshold may, depending on the context, refer to a value being greater than the threshold, greater than or equal to the threshold, less than the threshold, less than or equal to the threshold, equal to the threshold, or the like, depending on the context.

Although particular combinations of features are recited in the claims and disclosed in the specification, these combinations are not intended to limit the disclosure of various implementations. Features may be combined in ways not specifically recited in the claims or disclosed in the specification.

Although each dependent claim listed below may directly depend on only one claim, the disclosure of various implementations includes each dependent claim in combination with every other claim in the claim set. No element, act, or instruction used herein should be construed as critical or essential unless explicitly described as such.

The described herein demonstrates the advantages of combining the SP and CSEM signals, providing a new result.

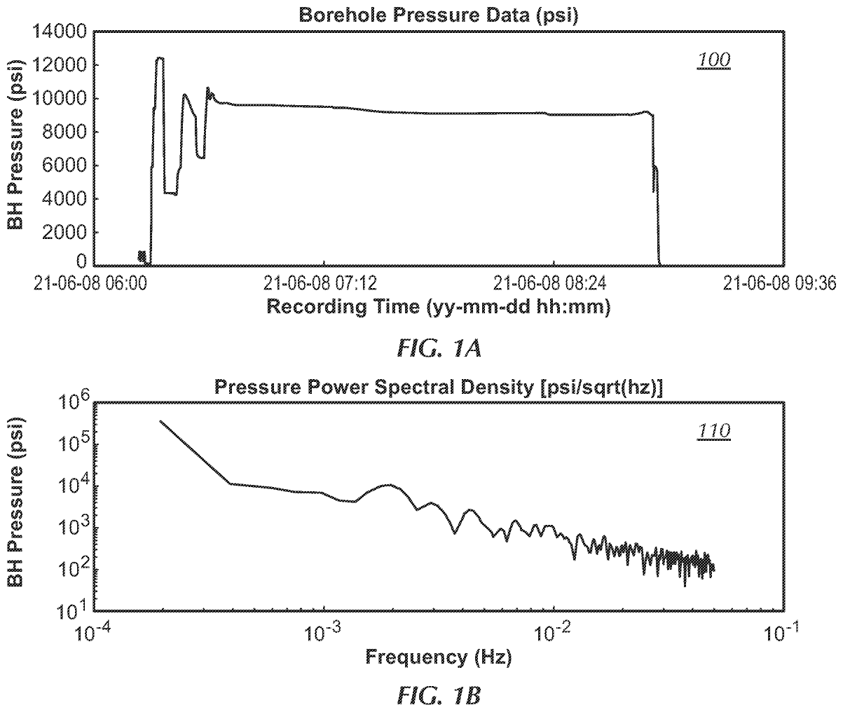

FIG. 1 is a pair of graphs illustrating an example frequency spectral analysis (110) compared to an example borehole pressure data (100). The frequency content in the pressure data falls to less than 0.1 Hz, close to DC.

An electric scattered field is defined as the total electric field difference between during and after the pumping operation and before the start of a pumping operation (background). Normally, the measured total field is normalized by the transmitter current.

An array of a plurality of surface CSEM receivers is deployed to record the response created by the CSEM transmitter providing power into the ground. Each member of the array of surface CSEM receivers thus receives a signal corresponding to the signal generated by the CSEM transmitter that is reflected from the subsurface. Each recording instrument in the CSEM transmitter and CSEM receiver array is precisely synchronized, preferably to better than 100 nanoseconds difference, across all devices with very low drift. In addition, each recording instrument has as high a sample rate as attainable, preferably at least 50,000 samples per second.

In some embodiments, the CSEM transmitter and receivers may be implemented as described in U.S. Pat. No. 9,810,804, entitled “Collecting and Transmitting Control Source Electromagnetic Signals,” issued Nov. 7, 2017, U.S. Pat. No. 11,221,429, entitled “COHERENT TRANSMIT AND RECEIVER BI-STATIC ELECTROMAGNETIC GEOPHYSICAL TOMOGRAPHY,” issued Jan. 11, 2022, both of which are incorporated herein by reference in its entirety for all purposes.

In applications involving carbon capture, utilization, and storage (CCUS) monitoring, the CSEM receiver array is preferably deployed in a sequence of concentric circles around a CCUS borehole casing. In other applications, the CSEM receiver array is preferably deployed above an area where fluid is being injected into the subsurface formation. In applications such as fracking, the CSEM receiver array is preferably deployed above a stage that is being fracked.

In general, the CSEM receiver array receives a secondary field a secondary EM field corresponding to the signals transmitted from the CSEM transmitter coupled with the streaming potential at a location where fluid is being injected into the subsurface formation, which can then be measured.

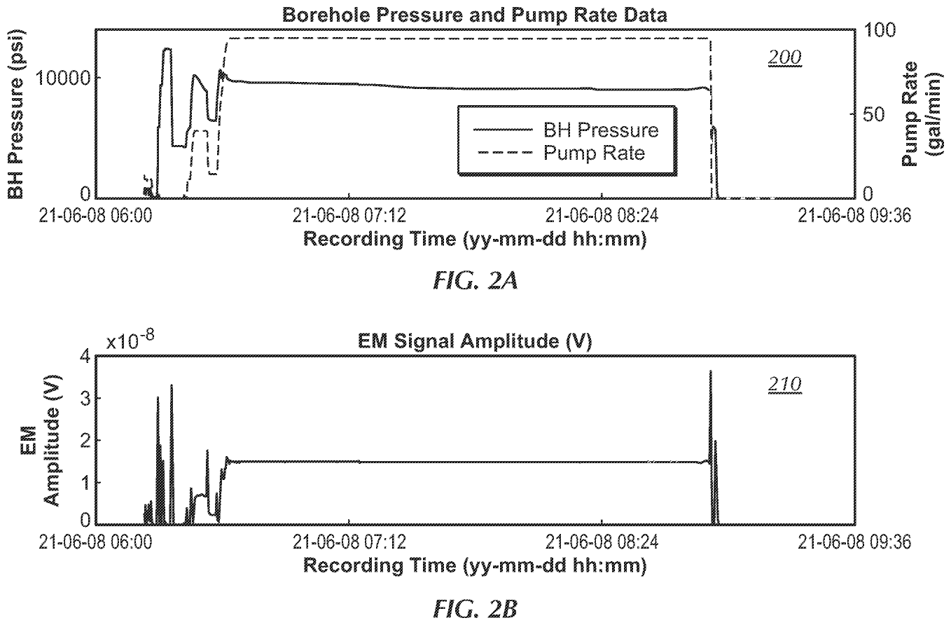

FIG. 2 is a pair of graphs illustrating a CSEM project. As shown in FIG. 2, in this CSEM project, the measured electric scattered fields (in time frequency format) of graph 210 at one sensor which was located at the surface, close to the injection well, show strong correlations with the injection well borehole pressure and pump flow rate of the graph 200, suggesting the dominance of the SP signal in the measured CSEM data. In FIG. 2, the frequency of the EM data is 100 Hz, while the pressure and flow rate are in a time domain.

However, one of the unexplained issues with this observation is the frequency content in the measured electromagnetic (EM) data. The EM trace along time in FIG. 2 are the scattered responses at 100 Hz, while the commonly accepted SP signal should be close to DC.

There exists an inconsistency between the observed CSEM scatter field data and the SP signal in terms of the frequency content.

Additionally, the signal strength of the CSEM scattered field as predicted by the usual 3D EM modeling at low frequencies, is approximately 1 to 2 orders of magnitude smaller than observed. This is a further inconsistency between observed and expected data.

The following figures show other real-world examples of this relationship.

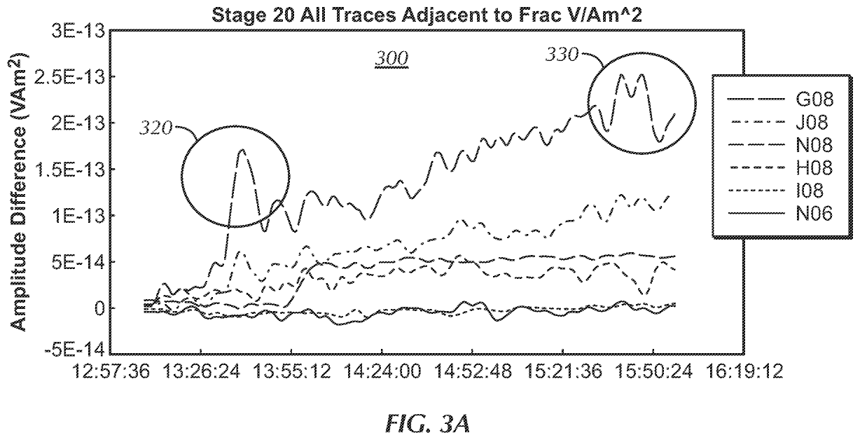

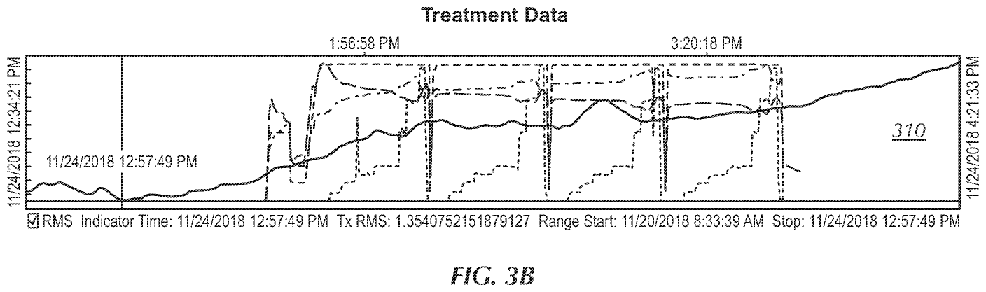

FIG. 3 is a pair of graphs that illustrate another example from a fracking operation of the relationship between pressure, injected fluid, proppant, and the scattered field CSEM response. In FIG. 3, measured CSEM scattered field signals (in time-frequency format) are illustrated at six sensor locations (300) and compared to borehole pressure and pump rate data (310). Note the frequency of the EM data is 10 Hz, while the pressure and flow rate were in a time domain. The EM scattered field response in areas 320 and 330 is an order of magnitude greater than conventional modeling prediction and indicates a pressure response from the streaming potential.

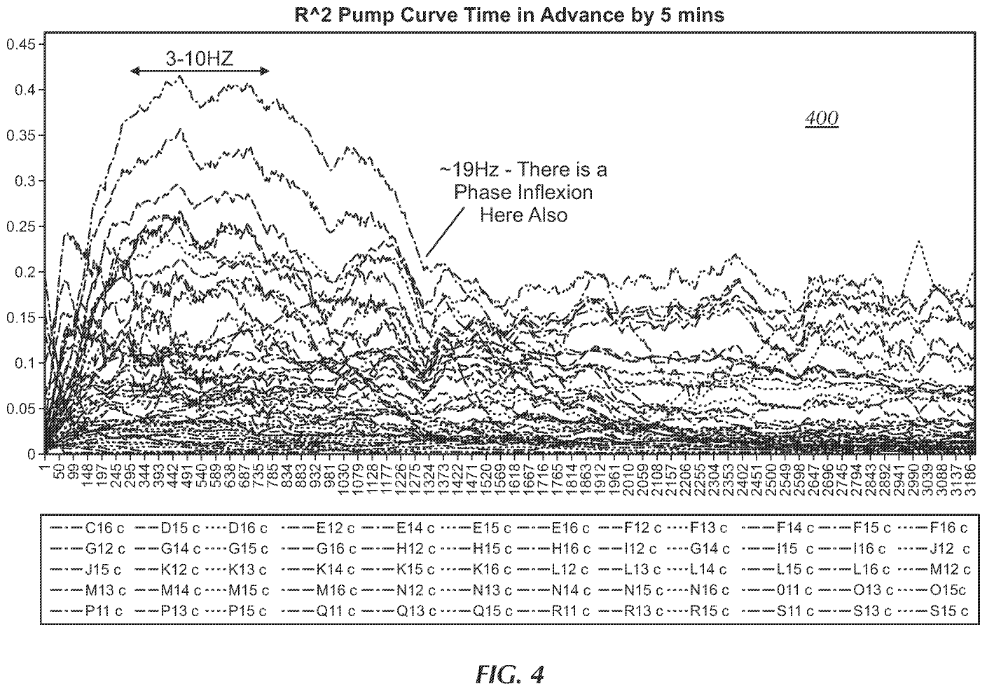

FIG. 4 is a graph 400 illustrating the results of a non-linear regression performed for all the data in the CSEM scattered field response from the data shown in FIG. 3 above. There is a clear peak for the sensors closest to the fracking operation between 3 and 10 hz. While the R\hat{ }2 value is low, there is apriori data relating to the location of the sensors, the frac operation location, and timing, that add significance to the result; the correlation only exists with pump flow and pressure data.

A New Geophysical Method

A new mechanism for the Streaming Potential (SP) signal in CSEM measurements can be extended from the normal Zeta potential theory: instead of the ion's relative displacement due to fluid flow, in the CSEM case, the ion's relative displacement is driven by the externally excited electromagnetic fields penetrating to the fluid flow zone.

Given this proposed mechanism, the correlations between the CSEM data and pressure and pump rate can be well explained from the frequency's perspective; consequently, a new geophysical method is proposed combining Streaming Potential and CSEM scatter field together to form spCSEM technology.

The new spCSEM technology will improve and expand the current stand-alone SP and CSEM methods in more applications in the energy industry, for example, in hydraulic fracturing, geothermal, exploration, tailings dam monitoring, and block cave mining, as well as in CCUS monitoring.

A New spCSEM Modeling Algorithm

Based upon the understanding of the mechanism of SP under an external EM exciting source, a new spCSEM modeling algorithm is disclosed. Besides the normal exciting current J^{e}, the streaming potential current J^{sp} can be treated as an additional source for generating the spCSEM's electromagnetic signal. The streaming potential current J^{sp} can be obtained by equation (1)

J^{sp}=|L*∇p (1)
where L is the cross-coupling coefficient between a fluid and electric flow in the coupled flow theory, and p is the pressure field, which may be solved in a reservoir simulation or geo-mechanical platform. Therefore, the modified frequency-domain EM equations for spCSEM might look like

∇×E+iωμH=0 (2)

∇×H−σE=J^{e}+J^{sp} (3)

Then by solving these equations, both electric and magnetic fields can be computed. This constitutes the spCSEM frequency-domain forward modeling engine, which can be used in the following inverse problem as outlined in equations (5), (6) and (7) below. From the spCSEM inversion, the conductivity or conductivity change of the injected fluid, or even more, saturation and permeability can be inferred.

Pressure Field to be Obtained from Reservoir Simulation

The streaming current density J^{sp} in equation (1) can be obtained by solving for the pressure field p in the whole domain. There are multiple ways to derive the pressure field, including: (1) by running a reservoir simulation based upon fluid flows, or (2) by solving a combination of poro-elastic fluid flow and mechanical equations.

Here we focus on solving for the pressure field by using a reservoir simulation because our primary targeted applications lie in either hydraulic fracturing or CO2 monitoring in CCUS.

Typically, reservoir simulation packages can be described in the following compositional governing equations.

$$∇ \cdot [ K {\sum }_{k = o , w , g} {x}_{ik} \frac{{ρ}_{k} {K}_{rk}}{{μ}_{k}} ( ∇ {p}_{k} + {γ}_{k} ∇ Z ) + {Q}_{i} = \frac{\partial }{\partial t} [ ϕ {\sum }_{k = o , w , g} {x}_{ik} {ρ}_{k} {S}_{k} ] \qquad ( 4 )$$

where
i=1, 2, . . . , Nc, where Nc is the number of compositional units;
K denotes the absolute permeability tensor;
k=o, w, g, representing the oil, water, and gas phase;
xᵢₖ is the fraction factor of phase kin unit I;
ρₖ, Kᵣₖ, and μₖ denote the phase density, relative permeability, and viscosity, respectively;
γₖ is the phase gravity;
Z is the vertical depth;
Qᵢ is the source term for injection or flowback of fluid;
ϕ is the porosity; and
Sₖ represents the phase saturation.

Together with related auxiliary equations for saturations, relative permeability, capillary pressure, PVT properties, and rock properties, both the pressure field pₖ and Sₖ can be simultaneously solved using a variety of numerical algorithms known to the art.

As is evident from the above the pressure field is a function of injection rate and petrophysical parameters, such as porosity, saturation, and permeability. Therefore, in theory, injection rate and any petrophysical parameters could be retrieved or inferred from the pressure field in the sense of formulating as an inverse problem. This opens a door for the spCSEM technique to be used in a new domain, which will be explained in the following sections.

Potential Applications of the spCSEM Technique

Through the streaming current density, conventional EM measurements are connected not only to electrical conductivity but also to the petrophysical parameters of the subsurface formation, as well as dynamitic injection and flowback and pressure field changes. Thus, the spCSEM technique can be used with applications of the traditional EM technologies in oil and gas exploration and production. The advantages of combining streaming potential techniques and CSEM techniques have not been recognized previously.

Application 1: Monitoring by Electrical Conductivity/Resistivity

This application is similar to traditional CSEM techniques. The difference here lies in that the streaming current is treated as an external exciting source, which could enhance the exciting field around the injected target of interest. Consequently, the resulting EM signal can be greatly enhanced. This means the spCSEM technique can be used in scenarios where the traditional CSEM methods fail to detect or monitor the injected plume through electrical conductivity and resistivity. This is especially true when steel-cased wells provide a conduit for electric current to flow forth and back from the surface of the earth, where both CSEM transmitter source and receivers are deployed, to the injection zone down the borehole.

Application 2: Imaging Pressure Field

Bottomhole pressure data are well known as vital for understanding reservoir performance and predicting future production behavior. The practical applications of pressure data may include reservoir volumetric calculations, understanding reservoir dynamic properties (e.g., permeability), fluid properties (e.g., density, phase behavior), drainage volumes (e.g., compartmentalization and flow barriers), etc.

Usually, pressure sensors are mounted along production wells to directly measure the reservoir dynamic pressure data.

In the spCSEM technique, as shown in equations (1)-(3), the pressure p or its gradient ∇p is connected with the measurement of both electric and magnetic fields, which can be abstractly described in a general function as

dᵢ=Fᵢ[m], i=1,2, . . . N_{d} (5)
where dᵢ denotes the measurement at receiver i with a total number of receivers N_{d},
Fᵢ is the function transforming the pressure or gradient of the pressure field to the EM fields, and
m is a vector of the unknown pressure p or its gradient ∇p at each gridlock or cell which is used to discretize the subsurface volume into N_{g} unknowns.

Following the standard inversion procedure, to recover the unknowns m, one can define an objective function of the data matching in the least-squared sense as

ϕ_{d}=½Σᵢ₌₀^{N}^{_{d}}∥dᵢ−Fᵢ∥² (6)

So the optimization of the inverse problem can be represented by

$$m = arg {min}_{m} {ϕ}_{d} \qquad ( 7 )$$

subject to constraints on m.

If we assume the conductivity's effect is minimal in some cases, then any changes in the electrical or magnetic (E or H) fields can be attributed to the changes in pressure or its gradient.

This inversion process can be carried out at each time step separately or by putting all the time-lapse data together once into the inversion system, and the dynamic unknowns m can be obtained.

Therefore, the spCSEM technique can be used as an alternative tool for imaging the dynamic pressure data in the reservoir model. This can be extremely valuable in evaluating the performance of reservoir management.

Application 3: Imaging Saturation or Permeability

The saturation and permeability of a formation refers to the amount of fluid that is present in a rock formation and the ease or difficulty of the fluid flow in the matrix. These are critical parameters that determine the potential for hydrocarbon production. The determinations of these parameters in the oil and gas industry involve the use of various methods such as well logging, core analysis, pressure transient testing, and production testing.

Here we present a different technique for this purpose.

Along the same line as discussed in Application 2, we can go further to connect the E and H measurements in spCSEM with petrophysical parameters, for example, saturation or permeability of the reservoirs together. In other words, using the same methodology as shown in equations (5)-(7), the saturation or permeability can be recovered from the EM signal. The only change one needs to make is to replace the forward modeling function Fᵢ in equation (5) with a similar function \tilde{F}ᵢ, which transforms the saturation or permeability into EM fields for the 3D model of the investigation.

Of course, to focus on one specific parameter, either saturation or permeability, one has to make some assumptions about the rest parameters. This may be valid only in some special circumstances. However, in theory, it is indeed a potential application of spCSEM.

Indeed, one must bear in mind that among all the practical methods to predict permeability, imaging permeability using spCSEM data will be unique to the field or formation for which it is developed.

Application 4: Determining the Source Term—Injection or Flowback Rate

Looking at equation (4), the source term Qᵢ denotes the injection or flowback rate. It is evident to observe that the pressure field, and consequently the EM measurements in the spCSEM will be directly influenced by this source term. Therefore it may be possible to determine the injection or flowback rate by analyzing the observed EM signal during the injection or flowback phase.

In summary, the spCSEM technique provides a remote sensing geophysical tool for monitoring the pressure field and injected water or CO2 plumes in terms of electrical conductivity, saturation, or permeability in hydraulic fracturing, CCUS, and geothermal management.

While certain example embodiments have been described in detail and shown in the accompanying drawings, it is to be understood that such embodiments are merely illustrative of and not devised without departing from the basic scope thereof, which is determined by the claims that follow.

We claim:

1. A method for monitoring carbon capture, utilization, and storage (CCUS), comprising:
positioning a controlled source electromagnetic (CSEM) transmitter on a surface of the earth relative to a CCUS borehole casing;
positioning a plurality of CSEM receivers relative to the CCUS borehole casing, synchronized with the CSEM transmitter;
transmitting signals from the CSEM transmitter into a subsurface formation about the CCUS borehole casing;
receiving by the plurality of CSEM receivers a secondary electromagnetic (EM) field corresponding to the signals transmitted from the CSEM transmitter coupled with a streaming potential at a location where fluid is being injected into the subsurface formation;
measuring the secondary EM field; and
calculating a pressure field by performing an inversion on an objective function based on the secondary EM field and a forward modeling function transforming a pressure or gradient of the pressure field to the secondary EM field.

2. The method of claim 1, wherein positioning the plurality of CSEM receivers comprises positioning the plurality of CSEM receivers in a sequence of concentric circles around the CCUS borehole casing.

3. The method of claim 1, wherein calculating a pressure field by performing an inversion comprises performing the inversion at each time step separately.

4. The method of claim 1, wherein calculating a pressure field by performing an inversion comprises performing the inversion on a combination of all time-lapse data.

5. A method of imaging saturation or permeability of a formation, comprising:
positioning a controlled source electromagnetic (CSEM) transmitter on a surface of the earth relative to a borehole;
positioning a plurality of CSEM receivers relative to the borehole, synchronized with the CSEM transmitter;
transmitting signals from the CSEM transmitter into a subsurface formation about the borehole;
receiving by the plurality of CSEM receivers a secondary electromagnetic (EM) field corresponding to the signals transmitted from the CSEM transmitter coupled with a streaming potential at a location where fluid is being injected into the subsurface formation;
measuring the secondary EM field; and
calculating a saturation or permeability of the formation by performing an inversion on an objective function based on the secondary EM field and a function transforming saturation or permeability into the secondary EM field.

6. The method of claim 5, wherein positioning the plurality of CSEM receivers comprises positioning the plurality of CSEM receivers above a stage that is being fracked.

7. The method of claim 5, further comprising:
creating a 3D model of the saturation or permeability of the formation.

8. A method of determining an injection or flowback rate into or from a subsurface formation, comprising:
positioning a controlled source electromagnetic (CSEM) transmitter on a surface of the earth relative to a borehole;
positioning a plurality of CSEM receivers relative to the borehole, synchronized with the CSEM transmitter;
transmitting signals from the CSEM transmitter into a subsurface formation about the borehole;
receiving by the plurality of CSEM receivers a secondary electromagnetic (EM) field corresponding to the signals transmitted from the CSEM transmitter coupled with a streaming potential at a location where fluid is being injected into the subsurface formation;
measuring the secondary EM field; and
performing a reservoir simulation based on the injection or flowback rate by performing an inversion on an objective function based on the secondary EM field and a function transforming a pressure or gradient of a pressure field to the secondary EM field.

9. The method of claim 8, wherein positioning the plurality of CSEM receivers comprises positioning the plurality of CSEM receivers above an area where fluid is being injected into the subsurface formation.

10. A method of calculating electrical and magnetic fields in a subsurface formation, comprising:
positioning a controlled source electromagnetic (CSEM) transmitter on a surface of the earth relative to a borehole;
positioning a plurality of CSEM receivers relative to the borehole, synchronized with the CSEM transmitter;
transmitting signals from the CSEM transmitter into a subsurface formation about the borehole;
receiving by the plurality of CSEM receivers a secondary electromagnetic (EM) field corresponding to the signals transmitted from the CSEM transmitter coupled with a streaming potential at a location where fluid is being injected into the subsurface formation;
measuring the secondary EM field; and
calculating a streaming potential current from a cross-coupling coefficient between a fluid and electric flow and a pressure field;
calculating electrical and magnetic fields based on an exciting current and a streaming potential current.

11. The method of claim 10, further comprising:
performing an inversion on an objective function based on the secondary EM field and a function transforming a pressure or gradient of the pressure field to the secondary EM field.

12. The method of claim 10, wherein the pressure field is derived by running a reservoir simulation based on fluid flows.

13. The method of claim 10, wherein the pressure field is derived by solving a combination of poro-elastic fluid flow and mechanical equations.
